(19) United States
(12) Patent Application Publication
(10) Pub. No.: US 2011/0052886 A1
(43) Pub. Date: Mar. 3, 2011

(54) COMPOSITION SCREEN-PRINTABLE ON POLYVINYL BUTYRAL

(75) Inventors: Jean-Edouard De Salins, Paris (FR); Thierry Dumenil, Margny Les Compiegne (FR); Jean-Claude Mauvais, Sevran (FR)

(73) Assignee: SAINT-GOBAIN GLASS FRANCE, Courbevoie (FR)

(21) Appl. No.: 12/933,580

(22) PCT Filed: Mar. 16, 2009
(86) PCT No.: PCT/FR09/50424

§ 371 Date: Nov. 15, 2010

(30) Foreign Application Priority Data
Mar. 19, 2008 (FR) 0851768

(51) Int. Cl. C08L 29/04; B32B 3/10; B41M 1/12

(52) U.S. Cl. 428/195.1; 524/557; 101/129

(57) ABSTRACT

The invention relates to
a composition suitable for printing, via screen printing, a sheet of polyvinyl butyral intended to be part of a laminated glazing unit, comprising at least one polyvinyl butyral resin having a molecular weight at most equal to 50 000 and at least one solvent;
a process for printing, via screen printing, a sheet of polyvinyl butyral intended to be part of a laminated glazing unit, characterized in that a composition defined previously is applied to the sheet, through a screen-printing screen and in that the thickness of the wet layer of composition applied compensates for the roughness of the sheet;
a sheet of polyvinyl butyral intended to be part of a laminated glazing unit and printed, via screen printing, using a composition defined previously;
a laminated glazing unit comprising one such sheet of polyvinyl butyral; and
an application of such a laminated glazing unit as motor vehicle glazing, at least one portion of the periphery of which is opacified, in particular darkened.

The invention relates to the field of laminated glazing units, commonly constituted of two sheets of glass bonded to one another by means of a sheet of polyvinyl butyral for example.

Laminated glazing units have many uses: a layer that reflects solar radiation, making it possible to lower the temperature of the instrument panel and the ambient temperature in the passenger compartment, a support for the interior rearview mirror, electric current feed busbars especially for an ITO layer or a network of heating wires, an upper strip that filters solar radiation of optionally graduated coloration, a rain detector, etc. Laminated glazing units are thus printed for various purposes: edge of the glazing unit opacified over its entire periphery in order to protect the underlying adhesive and hide the body components or seals from the view of an observer outside of the vehicle, markings relating to the manufacture, or to various standards, opacified surface in order to hide the base of the interior rear-view mirror from the view of an observer outside of the vehicle.

The printing of laminated glazing units may aim to opacify a portion of the surface thereof, with black or any other color. It may moreover have the objective of tinting, while preserving a certain transparency, or even a high light transmission, compatible with the current standards for a windshield.

Finally, the result of printing laminated glazing units may not be visible in the absence of ultraviolet radiation, for example emitted from the inside of the vehicle: this is the case for printing of the interior face of the glazing unit with a varnish that contains phosphors (the interlay adhesive of the glazing unit does not allow the ultraviolet rays from solar radiation through).

It is customary to produce such printing on sheets of flat glass, that is to say, where appropriate, before bending operations (this is because it is much more difficult to print onto curved surfaces). One preferred process is screen printing: it is able to provide the required optical qualities: good coverage, opacity and resolution, and can be easily industrialized. The printing composition must however have short drying times, compatible with an in-line process. Drying times that are too long would not make it possible to carry out an in-line process, but would require intermediate storage and finally an unacceptable cost premium.

Furthermore, in the case of an industrial in-line process, it is sought to carry out the screen printing in a single pass.

Screen printing onto sheets of flat glass is not without drawbacks. In particular, the sheets of glass, during the bending thereof, in pairs, come into physical contact with one another or with the mechanical components of the bending equipment. This physical contact requires the prior use of an additional furnace for the annealing of the printing composition, in order to prevent the printed surfaces that are insufficiently hardened and dried from being adversely affected.

This problem could be solved by carrying out the screen printing on the interlayer adhesive sheets and no longer on the glass sheets. Until now, it was still not known how to carry out printing, via screen printing in a single pass and with relatively short drying times on substrates made of sheets of flexible plastic such as polyvinyl butyral, of opaque or transparent colored designs, or else of designs containing any particles (metallic particles, SnO₂:In particles, SnO₂:F particles, etc.) or phosphors, etc.

In any case, printing is sought that has clear outlines, with no blurring, and with a required definition as a function of the application.

In the case of opaque coloration, the following are furthermore sought:
good coverage, which is expressed by the complete absence of transparency in the form of pinholes; and
a required opacity corresponding to an optical density at least equal to 3, preferably to 4.

In the case of transparent coloration, an absence of agglomeration and of diffusion and a haze that doesn't exceed 1% are sought.

The objective of the invention is therefore the provision of a process of screen printing onto an interlayer polyvinyl butyral sheet of a laminated glazing unit, having the combination of the aforementioned advantages, in particular that can be carried out in a single pass with “touch-dry” times that do not exceed 10 minutes, preferably 5 minutes and in particular 2 minutes.

This objective is achieved by the invention, one subject of which is a composition suitable for printing, via screen printing, a sheet of polyvinyl butyral intended to be part of a laminated glazing unit, characterized in that it comprises at least one polyvinyl butyral resin having a molecular weight at most equal to 50 000 and at least one solvent.

This composition may comprise a mixture of several different polyvinyl butyral resins having molecular weights at most equal to 50 000.

Thus, the invention makes it possible to achieve the high quality required defined above with a single screen-printing pass and short touch-dry times.

Preferably, the polyvinyl butyral resin has a molecular weight at most equal to 40 000, preferably 30 000. This feature is even necessary in the case of black opaque printing or opaque printing of any color. (It is also advantageous for phosphor and transparent colored printing, for which a polyvinyl butyral resin having a molecular weight up to 50 000 may however also be used).

Advantageously, the polyvinyl butyral resin has a molecular weight at least equal to 10 000, preferably to 15 000.

It is moreover preferred that the [OH] content of the polyvinyl butyral resin corresponds to a maximum weight percentage of polyvinyl alcohol of 22%, preferably 20% and in particular 18% and a minimum weight percentage of 9%, preferably 11% and in particular 13%.

Preferably, the glass transition temperature T_{g} of the polyvinyl butyral resin is at most equal to 70° C.

According to other advantageous features of the composition of the invention:
it comprises 2 to 35% by weight of polyvinyl butyral resin;
it comprises 1 to 50% by weight of at least one pigment and/or one other particle and/or a dye and/or a phosphor; it may therefore be the mixture of several of the latter; in this regard, it must be pointed out that the invention allows the use of remarkably high proportions of pigments, hence remarkable opacities, indicated by optical densities which may reach values of at least 4, or even 5, are obtained without furthermore impeding the implementation of the screen printing.

The dimensions of the particles of pigments, others and phosphors are from 0 to 5 μm.

Furthermore, 40 to 65% by weight of the pigments are advantageously coated.

The pigments, defined in particular by their CAS (Chemical Abstracts Service, American Chemical Society) No. and their CI (Color Index) No., may be chosen from those from the table below.

| Pigments | CAS No. | CI No. |
|---|---|---|
| Yellow 13 | 13515-40-7 | Yellow 13 |
| Monoazo yellow | 6486-23-3 | Yellow 3 |
| Benzimidazolone yellow | 31837-42-0 | Yellow 151 |
| Monoazo yellow | 12225-18-2 | Yellow 97 |
| Quinacridone pink | 980-26-7 | Red 122 |
| Quinacridone violet | 1047-16-1 | Violet 19 |
| Dioxazine violet | 6358-30-1 | Violet 23 |
| Carbon black | 1333-86-4 | Black 7 |
| Black iron oxide | 1317-61-9 | |
| Phthalocyanine blue | 147-14-8 | Blue 15.3 |
| Phthalocyanine green | 2786-76-7 | Green 7 |
| Titanium dioxide | 13463-67-7 | |

As another particle, mention may be made of the particles of ITO (SnO₂:In), or of SnO₂:F in view of forming, for example, athermic coatings, that absorb infrared rays.

Dyes which may be used within the context of the invention, defined by their type and the CI No., are the following.

| Dyes | Type | CI No. |
|---|---|---|
| Yellow | Cr complex | Yellow 88 |
| Yellow | Co complex | Yellow 25 |
| Orange | Co complex | Orange 11 |
| Brown | Cr complex | Brown 43 |
| Red | Cr complex | Red 130 |
| Red | Cr complex | Red 122 |
| Blue | Cu-phthalocyanine | Blue 136 |
| Blue | Cu-phthalocyanine | Blue 70 |
| Black | Cr complex | Black 29 |

As examples of phorphors, use may be made of the following, defined by their formula.

| Phosphors | Formula |
|---|---|
| Green | Zn₂SiO₄:Mn |
| Blue | BaMgAl₁₀O₁₇:Eu |
| Yellow | Y₂₀₂S:Eu, Sm + BaMgAl₁₀O₁₇ |
| Yellow | Beta-Quinophthalone |
| Red | Y₂O₃:Eu |
| Red | Y₂O₂S:Eu |

Moreover, it is appreciated that the solvent solubilizes the polyvinyl butyral resin and does not deform the sheet of polyvinyl butyral at the surface.

The solvent is opportunely chosen from the following.

| Solvents | CAS No. |
|---|---|
| Diacetone alcohol | 123-42-2 |
| Benzyl alcohol | 100-51-6 |
| 1-Methoxy-2-propanol | 107-98-2 |
| Butyl glycol | 111-76-2 |
| Dipropylene glycol monomethyl | 34590-94-8 |
| ether (DPM) | |
| Methoxy propanol acetate | 108-65-6 |
| Acetic acid, 3-methoxy-n-butyl | 4435-53-4 |
| ester (butoxyl) | |
| Glycolic acid, n-butyl ester | 7397-62-8 |
| (Polysolvant O) | |
| Dibasic esters (DBE) | 1119-40-0/106-65-0/ |
| | 627-93-0 |
| Cyclohexanone | 108-94-1 |

According to other preferred features of the composition:
it comprises 30 to 75% by weight of solvent;
0.2 to 3% by weight of a thixotropic agent consisting of a silica or several silicas as a mixture.

Another subject of the invention is a process for printing, via screen printing, a sheet of polyvinyl butyral intended to be part of a laminated glazing unit, characterized in that a composition as described above is applied to the sheet, through a screen-printing screen and in that the thickness of the wet layer of composition applied compensates for the roughness of the sheet, being in particular at least equal to 14 μm. During the drying of the composition, certain surface irregularities of the sheet of polyvinyl butyral may reappear, even more when a portion of the composition may then be absorbed by the sheet. These irregularities are favorable to the degassing during the assembly of the laminate.

This process provides the desired high quality in a single pass. According to one particularly advantageous feature, it does not require any heating means, but may be carried out at low temperature.

Another subject of the invention is a sheet of polyvinyl butyral intended to be part of a laminated glazing unit and printed, via screen printing, using a composition described above. In one particular embodiment, at least one portion of the surface of the sheet (the printed portion) has an optical density at least equal to 4, preferably to 5.

Other subjects of the invention consist of
a laminated glazing unit comprising such a sheet of polyvinyl butyral; and
the application of such a laminated glazing unit, for instance motor vehicle glazing, at least one portion of the periphery of which is opacified, in particular darkened.

The application of this glazing unit in the construction industry is however also part of the invention.

The invention is illustrated by the following examples, in which all the amounts under columns entitled “Formula” are percentages by weight.

### EXAMPLE 1

Screen printing is carried out in a single pass on an interlayer polyvinyl butyral sheet of a laminated glazing unit. The temperature is stabilized at 14-16° C. in order to guarantee a better surface flatness of the support and prevent it from being tacky.

The opaque black printing composition below is used.

| Opaque black | Formula/100 | Formula min/max |
|---|---|---|
| PVB resin CAS No. 63148-65-2, | 12 | 11/13 |
| 68648-78-2 MW 15 000 to | | |
| 30 000/OH 14/18 | | |
| Carbon black | 10 | 8/12 |
| Black iron oxide | 30 | 28/32 |
| Wetting agent and dispersant | 3 | 2/4 |
| of modified polyester type in | | |
| solution in white spirit | | |
| Hydrophilic fumed silica CAS | 1 | 0.5/1.5 |
| 7631-86-9 Specific surface | | |
| area (BET): 350/410 | | |
| Cyclohexanone | 38 | 37/39 |
| Dipropylene glycol monomethyl | 5 | 4/7 |
| ether (DPM) | | |
| Tension additive: polydimethyl | 1 | 0.5/1.5 |
| siloxane | | |

The desired high quality of coverage—lack of pin holes, opacity, sharpness of the contours, definition, lack of blurring, is achieved.

The touch-dry time is around two minutes.

### COMPARATIVE EXAMPLE 1

The preceding example is reproduced with the following composition.

| Opaque black | Formula/100 | Formula min/max |
|---|---|---|
| PVB resin CAS No. 63148-65-2, | 7.5 | 7/8 |
| 68648-78-2 MW 50 000 to | | |
| 60 000/OH 18/20 | | |
| Carbon black | 7 | 6/8 |
| Black iron oxide | 28 | 27/29 |
| Wetting agent and dispersant | 3 | 2/4 |
| of modified polyester type in | | |
| solution in white spirit | | |
| Hydrophilic fumed silica CAS | 1 | 0.5/1.5 |
| 7631-86-9 Specific surface | | |
| area (BET): 350/410 | | |
| Cyclohexanone | 47.5 | 46/50 |
| Dipropylene glycol monomethyl | 5 | 4/7 |
| ether (DPM) | | |
| Tension additive: polydimethyl | 1 | 0.5/1.5 |
| siloxane | | |

With this composition, characterized by a relatively high molecular weight, a low opacity (presence of pin holes) is obtained, the passage in the screen-printing screen is more difficult.

### EXAMPLE 2

Opaque color printing is carried out by reproducing example 1 with the composition below.

| Opaque colors | Formula/100 | Formula min/max |
|---|---|---|
| PVB resin CAS No. 63148-65-2, | 20 | 19/21 |
| 68648-78-2 MW 15 000 to | | |
| 30 000/OH 14/18 | | |
| Yellow 151 pigment | 15 | 14/16 |
| Wetting agent and dispersant | 3 | 2/4 |
| of modified polyester type in | | |
| solution in white spirit | | |
| Hydrophilic fumed silica CAS | 1 | 0.5/1.5 |
| 7631-86-9 Specific surface | | |
| area (BET): 350/410 | | |
| Cyclohexanone | 55 | 54/56 |
| Dipropylene glycol monomethyl | 5 | 4/7 |
| ether (DPM) | | |
| Tension additive: polydimethyl | 1 | 0.5/1.5 |
| siloxane | | |

The same high quality is obtained as in example 1.

EXAMPLE 3

Transparent color printing is carried out by reproducing example 1 with the composition below.

| Transparent colors | Formula/100 | Formula min/max |
|---|---|---|
| PVB resin CAS No. 63148-65-2, | 20 | 19/21 |
| 68648-78-2 MW 15 000 to | | |
| 30 000/OH 14/18 | | |
| Red 122 dye | 10 | 9/11 |
| Wetting agent and dispersant | 3 | 2/4 |
| of modified polyester type in | | |
| solution in white spirit | | |
| Hydrophilic fumed silica CAS | 1 | 0.5/1.5 |
| 7631-86-9 Specific surface | | |
| area (BET): 350/410 | | |
| Cyclohexanone | 60 | 59/61 |
| Dipropylene glycol monomethyl | 5 | 4/7 |
| ether (DPM) | | |
| Tension additive: polydimethyl | 1 | 0.5/1.5 |
| siloxane | | |

The same high quality is obtained as in example 1.

In addition, in terms of transparency an excellent optical quality, an absence of agglomeration and of diffusion and a haze that does not exceed 1% are observed.

EXAMPLE 4

Phosphor pigment printing is carried out by reproducing example 1 with the composition below.

| Phosphors | Formula/100 | Formula min/max |
|---|---|---|
| PVB resin CAS No. 63148-65-2, | 22 | 21/22 |
| 68648-78-2 MW 15 000 to | | |
| 30 000/OH 14/18 | | |
| Blue BaMgAl₁₀O₁₇:Eu phosphor | 3 | 1/4 |
| pigment | | |
| Wetting agent and dispersant | 3 | 2/4 |
| of modified polyester type in | | |
| solution in white spirit | | |
| Hydrophilic fumed silica CAS | 1 | 0.5/1.5 |
| 7631-86-9 Specific surface | | |
| area (BET): 350/410 | | |
| Cyclohexanone | 65 | 63/66 |
| Dipropylene glycol monomethyl | 5 | 4/7 |
| ether (DPM) | | |
| Tension additive: polydimethyl | 1 | 0.5/1.5 |
| siloxane | | |

The same high quality is obtained as in examples 1, 2 and 3.

1. A composition comprising at least one polyvinyl butyral resin having a molecular weight at most equal to 50 000 and at least one solvent.

2. The composition as claimed in claim 1, wherein the polyvinyl butyral resin has a molecular weight at most equal to 40 000.

3. The composition as claimed in claim 1, wherein the polyvinyl butyral resin has a molecular weight at least equal to 10 000.

4. The composition as claimed in claim 1, wherein the [OH] content of the polyvinyl butyral resin corresponds to a maximum weight percentage of polyvinyl alcohol of 22%, and a minimum weight percentage of 9%.

5. The composition as claimed in claim 1, comprising 2 to 35% by weight of polyvinyl butyral resin.

6. The composition as claimed in claim 1, comprising 1 to 50% by weight of at least one pigment and/or one other particle and/or a dye and/or a phosphor.

7. The composition as claimed in claim 1, wherein the solvent solubilizes the polyvinyl butyral resin and does not deform the polyvinyl butyral sheet at the surface.

8. The composition as claimed in claim 1, comprising 30 to 75% by weight of solvent.

9. The composition as claimed in claim 1, comprising 0.2 to 3% by weight of a thixotropic agent consisting of a silica or several silicas as a mixture.

10. A process for printing, via screen printing, a sheet of polyvinyl butyral comprising applying a composition as claimed in claim 1 to the sheet through a screen-printing screen, wherein the thickness of the wet layer of composition applied compensates for the roughness of the sheet.

11. The process as claimed in claim 10, wherein the thickness of the wet layer of composition applied is at least equal to 14 μm.

12. A sheet of polyvinyl butyral printed, via screen printing, with a composition as claimed in claim 1.

13. The sheet of polyvinyl butyral as claimed in claim 12, wherein at least one portion of its surface has an optical density at least equal to 4.

14. A laminated glazing unit comprising a sheet of polyvinyl butyral as claimed in claim 12.

15. A motor vehicle glazing comprising the laminated glazing unit as claimed in claim 14 wherein at least one portion of the periphery of which is opacified.
